(19) United States
(12) Patent Application Publication
(10) Pub. No.: US 2022/0203841 A1
(43) Pub. Date: Jun. 30, 2022

(54) Managing Nighttime Power for Solar-Powered Vehicles

(71) Applicant: LOON LLC, Mountain View, CA (US)

(72) Inventors: Sailesh Prabhu, Sunnyvale, CA (US); Jacob Roberts, San Francisco, CA (US)

(73) Assignee: LOON LLC, Mountain View, CA (US)

(21) Appl. No.: 17/137,950

(22) Filed: Dec. 30, 2020

(51) Int. Cl. B60L 8/00; B60L 58/13

(52) U.S. Cl. CPC B60L 8/003; B64B 1/40; B60L 2200/10; B60L 58/13

(57) ABSTRACT

The technology relates to managing nighttime power for solar-powered vehicles. A system may include a sunrise estimator for estimating a time until a next sunrise, a battery state estimator for estimating a battery state, a critical battery estimator for determining a battery threshold, below which subsystems may be powered off, and an alert monitor to determine, and communicate to the solar-powered vehicle, a charge threshold and a restart charge threshold. A method may include operating a vehicle in an operational power mode, estimating a time until a next sunrise, estimating a battery state, determining a preservation battery threshold based on the estimated time until the next sunrise and the estimated battery state, determining a minimum charge threshold based on the preservation battery threshold, monitoring a battery charge level of the vehicle throughout the night, and if the battery charge level drops below the minimum charge threshold, implementing a preservation power mode.

### BACKGROUND OF INVENTION

Many aircraft that remain afloat or in-flight for long periods of time (e.g., high altitude aircraft) rely on solar, wind, or other renewable sources of, power to operate onboard subsystems. In order to do so, the aircraft may collect energy in batteries, or other energy storage solutions, during times when the energy source (e.g., sun, wind) is available, and then rely on the stored energy when the energy source is not available.

In solar powered aircraft, power may be collected and stored in batteries during the day (i.e., sunrise to sunset), and then the aircraft may run solely on battery power at night (i.e., sunset to sunrise). For aircraft that remain in-flight for multiple days, weeks, months or even years, it is critical to manage power consumption during nighttime flight to ensure the aircraft does not lose power before sunrise. Where the aircraft needs to not only power its flight, but also power and maintain the health of components (i.e., subsystems) to provide services, such as data and network connectivity, surveillance and other types of data gathering (e.g., image capture, audio and video recording, weather and environmental data, telemetry), it is often not possible or practical to power all of these subsystems continuously. Conventional techniques of powering off subsystems completely to conserve energy can be damaging to such subsystems when the environment is too cold. Such exposure of hardware components to extremely cold environments (e.g., high altitudes above Earth's surface, such as the stratosphere or beyond) can damage the hardware components irrevocably.

Thus, there is a need for improved management of nighttime power for solar-powered vehicles.

### BRIEF SUMMARY

The present disclosure provides techniques for managing nighttime power for solar-powered vehicles. A nighttime power management system for a solar-powered vehicle may include a sunrise estimator configured to estimate a time until a next sunrise; a battery state estimator configured to estimate a battery state; a critical battery estimator configured to determine a battery threshold, below which one or more subsystems may be powered off; and an alert monitor configured to determine, and communicate to the solar-powered vehicle, a charge threshold and a restart charge threshold, the charge threshold indicating a first minimum battery charge below which a preservation power mode will be implemented by the solar-powered vehicle and the restart threshold indicating a second minimum battery charge above which the solar-powered vehicle may return to an operational power mode. In some examples, the battery threshold comprises a preservation battery threshold, the charge threshold being based on the preservation battery threshold. In some examples, the solar-powered vehicle is configured to shut off power to a first subset of non-flight critical subsystems in the preservation power mode. In some examples, the first subset of non-flight critical subsystems comprises one or more of a propulsion system, an altitude control system, and communication transmit and receive capabilities. In some examples, the solar-powered vehicle is configured to power on at least a communications unit, an altitude control system, and a plurality of heaters in the operational power mode. In some examples, the battery threshold comprises a critical battery threshold, below which a low power mode will be implemented by the solar-powered vehicle. In some examples, the solar-powered vehicle is configured to shut off power to a second subset of non-flight critical subsystems in the low power mode. In some examples, the second subset of non-flight critical subsystems comprises a communications unit and a plurality of heaters including a heater for a communications terminal. In some examples, the solar-powered vehicle is configured to maintain power to a set of flight critical subsystems during the preservation power mode, the low power mode, and the operational power mode, the set of flight critical subsystems including a flight termination unit. In some examples, the system also may comprise a termination subsystem, including a solar power estimator configured to estimate distribution of power available until the next sunrise; and a critical load estimator configured to estimate distribution of electrical load for operating in a low power mode until the next sunrise. In some examples, the system also may comprise a termination estimator configured to determine a probability of the solar-powered vehicle maintaining power to a set of flight critical subsystems until a next sunrise. In some examples, the set of flight critical subsystems includes one or both of an avionics subsystem and a landing system, the landing system including a flight termination unit. In some examples, the termination estimator is configured to determine the probability by performing a probabilistic computation algorithm. In some examples, the probabilistic computation algorithm comprises a plurality of Monte Carlo simulations. In some examples, the solar-powered vehicle is configured to maintain power to a set of flight critical subsystems during the preservation power mode, the low power mode, and the operational power mode, the set of flight critical subsystems including a flight termination unit. In some examples, comprising a flight planner configured to generate and modify a flight plan for the solar-powered vehicle, wherein the flight planner is configured to modify the flight plan in response to the battery state estimated by the battery state estimator. In some examples, the flight planner further is configured to modify the flight plan in response to an alert automatically sent by the alert monitor, the alert associated with the charge threshold and the restart threshold.

A method of managing power of a solar-powered vehicle during a night may include: operating the solar-powered vehicle in an operational power mode; estimating a time until a next sunrise; estimating a battery state; determining a preservation battery threshold based on the time until the next sunrise and the battery state; determining a minimum charge threshold based on the preservation battery threshold; monitoring a battery charge level of the solar-powered vehicle throughout the night; and after detecting the battery charge level dropping below the minimum charge threshold, implementing a preservation power mode. In some examples, the battery state comprises one or more of a battery temperature, a battery charge, and a battery voltage, of a battery on the solar-powered vehicle. In some examples, the method also may include determining a critical battery threshold, wherein a first subset of non-flight critical systems is shut off in the preservation power mode to avoid falling below the critical battery threshold. In some examples, the method also may include, after detecting the battery charge level dropping below the critical battery threshold, implementing a low power mode, wherein a second subset of non-flight critical systems is shut off. In some examples, the method also may include determining a restart charge threshold based on the preservation battery threshold and upon detecting the battery charge level rising back above a restart charge threshold, and returning the solar-powered vehicle to the operational power mode, wherein the restart charge threshold is a sufficient amount higher than the preservation power mode such that returning the solar-powered vehicle to the operational power mode will not cause the battery charge level to drop back below the minimum charge threshold within a given period of time.

### BRIEF DESCRIPTION OF THE DRAWINGS

FIGS. 1A-1B are diagrams of exemplary solar-powered vehicles, in accordance with one or more embodiments;

FIG. 2A is a simplified block diagram of an exemplary computing system forming part of the systems of FIGS. 1A-1B, in accordance with one or more embodiments;

FIG. 2B is a simplified block diagram of an exemplary distributed computing system that may be used for managing nighttime power for solar-powered vehicles, in accordance with one or more embodiments;

FIGS. 3A-3B are simplified block diagrams of exemplary systems for managing nighttime power for solar-powered vehicles, in accordance with one or more embodiments;

FIGS. 4A-4B are a charts illustrating exemplary battery charge levels and thresholds for changing power modes, in accordance with one or more embodiments; and

FIG. 5 is a flow diagram illustrating a method for managing nighttime power for solar-powered vehicles, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for managing nighttime power for solar-powered vehicles. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driving vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to managing nighttime power for solar-powered vehicles. A power management system for managing nighttime power for solar-powered vehicles may include a sunrise estimator, a battery state estimator, a critical battery estimator, and an alert monitoring system (e.g., alert monitor as described below). The sunrise estimator may be configured to estimate (e.g., model, calculate, compute) a time until a next sunrise (i.e., a time at which the sun is expected to reach a given height above the horizon (e.g., 0 degrees, 5 degrees, 10 degrees, 12 degrees, or more or less)), for example, based on current vehicle position and current position of the sun, or other parameters. The battery state estimator may be configured to estimate a battery state (e.g., temperature, voltage, charge) across all batteries in a vehicle's battery pack. The critical battery estimator may be configured to determine a critical battery threshold (e.g., a charge of approximately 15,000 coulombs for a battery pack comprising approximately a dozen Lithium ion battery cells, or other charge threshold that corresponds to a minimum voltage threshold (e.g., 30V-42V for a Lithium ion battery pack comprising a dozen battery cells) for a given battery system) and a preservation battery threshold for the battery pack based on the time until the next sunrise and the battery state.

To avoid falling below the preservation battery threshold, a first group of subsystems (e.g., Navigation, LTE communications, and communications terminals) may be disabled at night to preserve power. Below the preservation battery threshold, a second group of non-flight critical systems (i.e., mission critical and/or service critical systems) may be shut down to avoid falling below the critical battery threshold (e.g., power off communications unit completely, including heaters, which may operate a communications unit outside of a specification and incurs a risk of damaged communications hardware). Below the critical battery threshold, a third group of non-flight critical systems may be shut down or begin to be rendered inoperable (e.g., heaters to more sensitive components, including hardware components of a communications (e.g., LTE) subsystem, such as gimbals and terminals). In some examples, this third group of non-flight critical systems may remain powered off until they are needed again or until a next sunrise (e.g., subsystems that are sensitive to on/off cycles). Alert monitoring system may be configured to determine, and communicate to the vehicle, a minimum charge threshold and restart charge threshold, which define battery levels at which the vehicle should implement a preservation power mode (i.e., preservation mode) wherein non-flight critical components may be turned on and off, such thresholds residing above the critical battery threshold below. If the battery level falls below the minimum charge threshold, certain non-flight critical subsystems (e.g., communications equipment, altitude control system (ACS)) may be turned off to preserve power. The restart charge threshold may indicate the threshold at which the non-flight critical subsystems may be powered back on, and may be sufficiently higher than the minimum charge threshold such that restarting one or more non-flight critical subsystems will not cause the battery level to fall below the minimum charge threshold immediately or soon after restarting. In some examples, there may be separate thresholds determined for separate non-flight critical subsystems, or other methods of prioritizing shut down and restarting of said subsystems.

The power management system also may include a termination subsystem comprising a solar power estimator and critical load estimator the termination subsystem configured to determine a probability of the vehicle surviving a night (i.e., during which time the solar-powered vehicle is not receiving light (e.g., visible, infrared, ultraviolet) that it can convert into electrical energy) without cutting power to a flight critical subsystem (e.g., critical avionics and navigation, flight termination unit, landing systems). The solar power estimator may be configured to estimate an amount of power available until the next sunrise. The critical load estimator may be configured to estimate the electrical load of flight critical systems through the night (i.e., from sunset to the next sunrise). Based on the estimated amount of power available and electrical load, the termination subsystem may determine a probability of surviving the night without cutting power to a flight critical subsystem.

The power management system may preserve a vehicle's power at night by operating in one or more lower power modes at night. In some example, the vehicle may implement one or more power saving modes, wherein one or more non-flight critical subsystems (e.g., communications, altitude control system, propulsion system, heating), or aspects thereof, are shut down (e.g., functionally disabled by software, cut off from power, or otherwise disabled). In an example, there may be a single preservation power mode wherein power to all non-flight critical subsystems may be shut off simultaneously or in quick succession, to remain off until the system is ready to power all such subsystems back on. In another example, there may be two or more preservation power modes wherein a communications unit stops transmitting and receiving in a first preservation mode, ACS and/or propulsion capabilities are reduced in a second preservation mode, heating to all communications components shut off in a third preservation mode, heating to all components shut off in a fourth preservation mode, and so on. In some examples, the vehicle may be configured to implement a low power mode wherein battery level falls below the critical battery threshold, in which mode all subsystems are shut off except for those necessary for landing the vehicle (e.g., heaters are turned off to even temperature sensitive components that may suffer damage as a result).

In some examples, the power management system may return to an operational power mode after two or more conditions are met (e.g., the sun is a minimum height above the horizon (e.g., 5 degrees, 10 degrees, 12 degrees, or more or less), solar panels are generating a threshold amount of solar power (e.g., 300 W, 400 W, 500 W, or other amount sufficient to power most or all components in an operational power mode without drawing down battery power) or generating solar power at a threshold rate).

In some examples, in order to avoid entering a no-fly zone while in a preservation mode, a flight planning system also may be configured to constrain a flight to only ascend and descend to altitudes where remaining at the altitude for a predetermined period of time (e.g., 12 hours, 15 hours, a number of hours remaining until sunrise) will not result in the vehicle drifting into a no-fly zone. Thus, for a pre-sunset period of time (e.g., from one or a few minute(s) to an hour or more), a flight planner may implement this type of failsafe logic where it will construct plans that select only potential altitudes that meet this criterion. In some examples, where the system may determine probabilities (i.e., between 0% and 100%) that a flight trajectory at an altitude will result in a no-fly zone incursion, a risk threshold may be set such that altitudes at which the risk of a no-fly zone incursion is greater than a given percentage (e.g., 20%, 25%, 30%, or lower, in between, or higher) are not included in the flight plan.

Example Systems

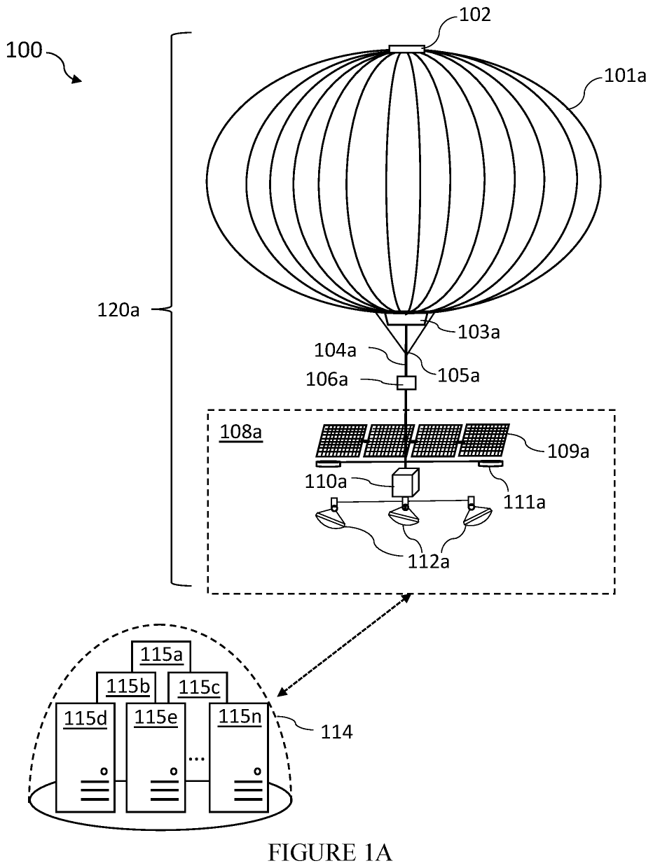

FIGS. 1A-1B are diagrams of exemplary solar-powered vehicles, in accordance with one or more embodiments. In FIG. 1A, there is shown a diagram of system 100 for control of aerial vehicle 120a. In some examples, aerial vehicle 120a may be a passive vehicle, such as a balloon or satellite, wherein most of its directional movement is a result of environmental forces, such as wind and gravity. In other examples, aerial vehicles 120a may be actively propelled. In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a and may serve to couple together various parts of balloon 101a. In other examples, plate 102 also may include a flight termination unit, such as one or more blades and an actuator to selectively cut a portion and/or a layer of balloon 101a. In other examples, plate 102 further may include other electronic components (e.g., a sensor, a part of a sensor, power source, communications unit). ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that may be inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength and stability to the balloon structure, and a ballonet, along with other structural components. In various embodiments, balloon 101a may be non-rigid, semi-rigid, or rigid.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 201 and/or 201a-n, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun, or otherwise actuated, by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors (i.e., RTDs), speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

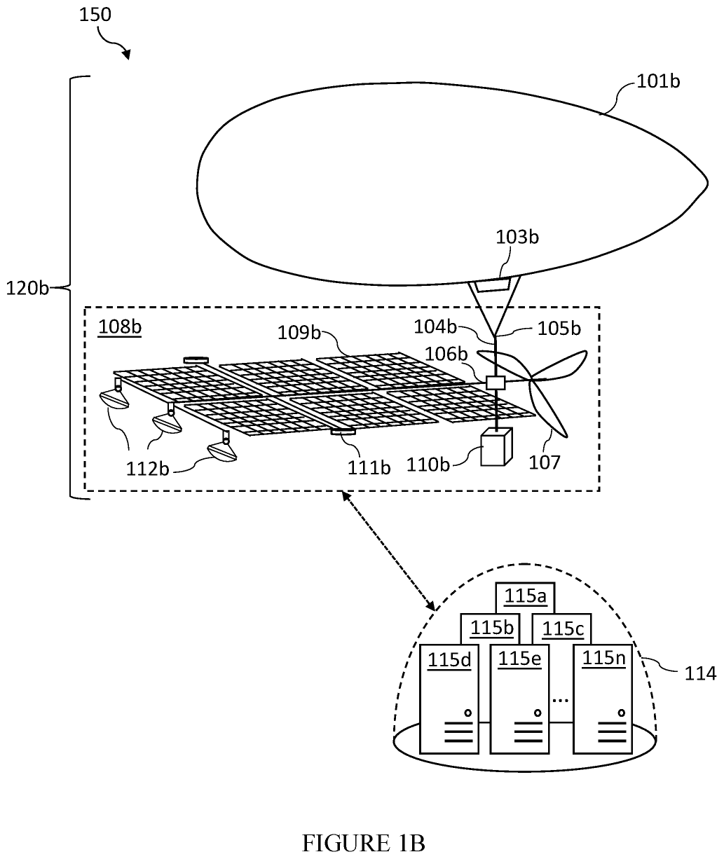

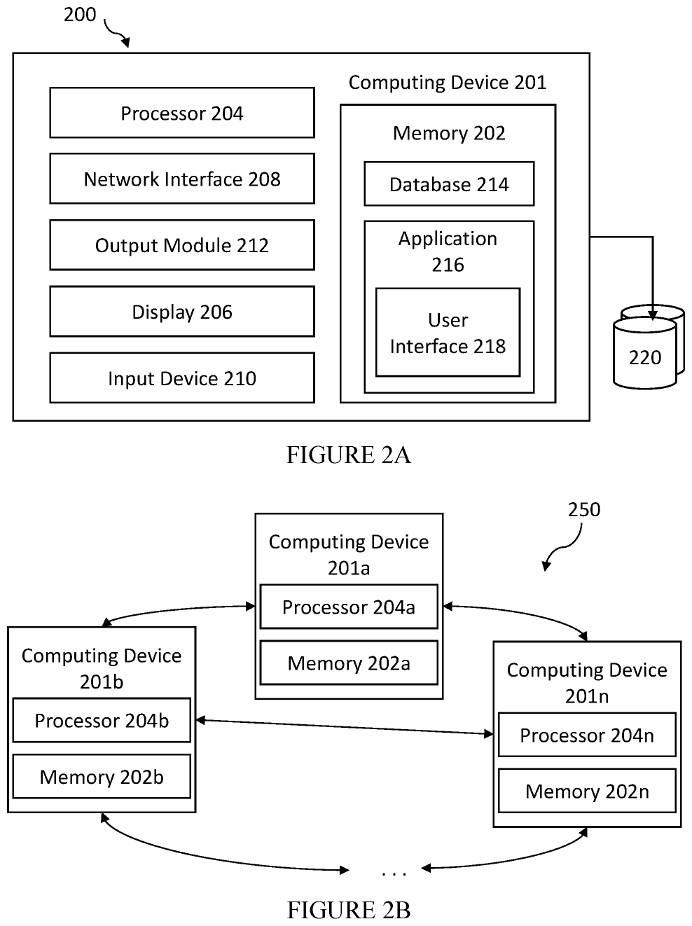

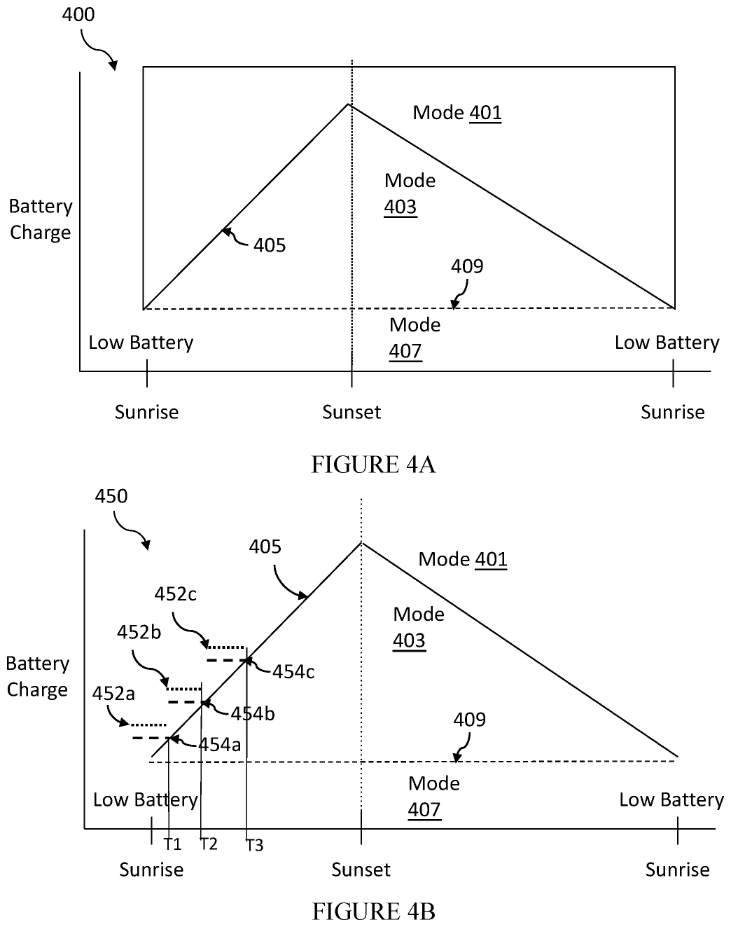

Ground station 114 may include one or more server computing devices 115a-n, which in turn may comprise one or more computing devices (e.g., computing device 201 in FIG. 2). In some examples, ground station 114 also may include one or more storage systems, either housed within server computing devices 115a-n, or separately (see, e.g., computing device 201 and repositories 220). In an example, ground station 114 may be a datacenter servicing various nodes of one or more networks (e.g., network 400 in FIG. 4). In another example, ground station 114 may comprise a terminal (e.g., on a gimbal) on Earth's surface configured to establish an mmWave link with a terminal on an aerial vehicle, as described herein. Ground station 114 may be connected to the Internet.

FIG. 1B shows a diagram of system 150 for control of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In some examples, balloon 101b may comprise an airship hull or dirigible balloon. In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties. In some examples, balloon 101b may include one or more fins (not shown) coupled to one or more of a rear, upper, lower, or side, surface (i.e., relative to a direction in which balloon 101b is heading).

As shown in FIGS. 1A-1B, aerial vehicles 120a-b may be largely wind-influenced aerial vehicles, for example, balloons carrying a payload (with or without propulsion capabilities). Techniques described herein also may be implemented in fixed wing high altitude drones (not shown) with gliding and/or full propulsion capabilities. Those skilled in the art will recognize that the systems and methods disclosed herein may similarly apply and be usable by various other types of aerial vehicles.

FIG. 2A is a simplified block diagram of an exemplary computing system forming part of the systems of FIGS. 1A-1B, in accordance with one or more embodiments. In one embodiment, computing system 200 may include computing device 201 and storage system 220. Storage system 220 may comprise a plurality of repositories and/or other forms of data storage, and it also may be in communication with computing device 201. In another embodiment, storage system 220, which may comprise a plurality of repositories, may be housed in one or more of computing device 201 (not shown). In some examples, storage system 320 may store state data (e.g., including power levels and other power-related data), commands, flight policies, and other types of information as described herein. This information may be retrieved or otherwise accessed by one or more computing devices, such as computing device 201 (or computing devices 201a-n in FIG. 2B) or server computing devices (e.g., 115a-n in FIGS. 1A-1B), in order to perform some or all of the features described herein. Storage system 220 may comprise any type of computer storage, such as a hard-drive, memory card, ROM, RAM, DVD, CD-ROM, write-capable, and read-only memories. In addition, storage system 220 may include a distributed storage system where data is stored on a plurality of different storage devices, which may be physically located at the same or different geographic locations. Storage system 220 may be networked to computing device 201 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 201 also may include a memory 202. Memory 202 may comprise a storage system configured to store a database 214 and an application 216. Application 216 may include instructions which, when executed by a processor 204, cause computing device 201 to perform various steps and/or functions, as described herein. Application 216 further includes instructions for generating a user interface 218 (e.g., graphical user interface (GUI)). Database 214 may store various algorithms and/or data, including neural networks (e.g., encoding flight policies, as described herein) and data regarding wind patterns, weather forecasts, historical and expected sunrise and sunset times, past and present locations of aerial vehicles (e.g., aerial vehicles 120a-b and/or vehicle 320), sensor data, map information, air traffic information, among other types of data. Memory 202 may include any non-transitory computer-readable storage medium for storing data and/or software that is executable by processor 204, and/or any other medium which may be used to store information that may be accessed by processor 204 to control the operation of computing device 201. Computing devices 201a-n, memory 202a-n, and processors 204a-n, in FIG. 2B may function the same or similarly.

Computing device 201 may further include a display 206, a network interface 208, an input device 210, and/or an output module 212. Display 206 may be any display device by means of which computing device 201 may output and/or display data. Network interface 208 may be configured to connect to a network using any of the wired and wireless short range communication protocols described above, as well as a cellular data network, a satellite network, free space optical network and/or the Internet. Input device 210 may be a mouse, keyboard, touch screen, voice interface, and/or any or other hand-held controller or device or interface by means of which a user may interact with computing device 201. In some examples, input device 201 may be used to apply flight tags (i.e., a flight engineer may tag a flight, for example, to selectively enable and/or disable certain commands, to enable and/or disable automated command sending while flight engineering is responding to an emergency, and other types of tags). In other examples, inputs to computing device 201 may be received from software and other programmed sources (e.g., configurations enabling and/or disabling command sending based on a software release for a flight, tweaking a duration that a subsystem is in one or more modes (e.g., any of the power saving modes described herein), and other configurations). Output module 212 may be a bus, port, and/or other interface by means of which computing device 201 may connect to and/or output data to other devices and/or peripherals.

In some examples computing device 201 may be located remote from an aerial vehicle (e.g., aerial vehicles 120a-b and/or vehicle 320) and may communicate with and/or control the operations of an aerial vehicle, or its control infrastructure as may be housed in avionics chassis 110a-b, via a network. In one embodiment, computing device 201 is a data center or other control facility (e.g., configured to run a distributed computing system as shown in FIG. 2B), and may communicate with a controller and/or flight computer housed in avionics chassis 110a-b via a network. As described herein, system 200, and particularly computing device 201, may be used for planning a flight path or course for an aerial vehicle based on wind and weather forecasts to move said aerial vehicle along a desired heading or within a desired radius of a target location. Various configurations of system 200 are envisioned, and various steps and/or functions of the processes described below may be shared among the various devices of system 200 or may be assigned to specific devices.

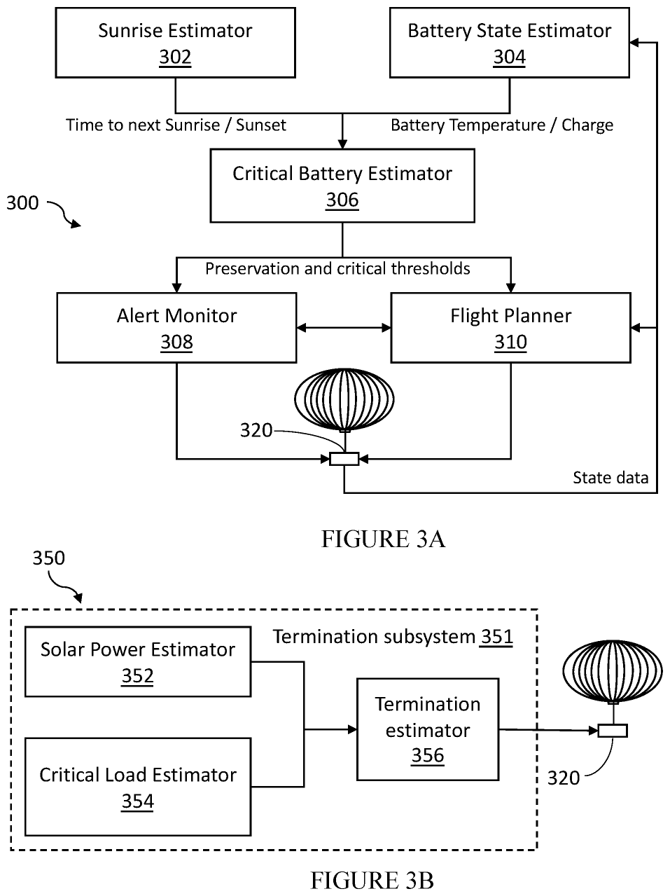

FIGS. 3A-3B are simplified block diagrams of exemplary systems for managing nighttime power for solar-powered vehicles, in accordance with one or more embodiments. System 300 may include sunrise estimator 302, battery state estimator 304, critical battery estimator 306, alert monitor 308, flight planner 310, and vehicle 320. In some examples, vehicle 320 may be the same or similar to one of aerial vehicles 120a-b. Sunrise estimator 302 may be configured to estimate a time until a next sunrise, for example, based on current vehicle position and current position of the sun, or other parameters, which may be provided to critical battery estimator 306 (e.g., sent automatically by sunrise estimator 302, periodically and/or in response to a query from critical battery estimator 306 or other triggering event). Battery state estimator 304 may be configured to estimate a battery state (e.g., temperature, voltage, charge) across some or all batteries in a battery system (i.e., battery pack) for vehicle 320, for example, based on state data obtained from vehicle 320. Such battery state information also may be provided to critical battery estimator 306. Critical battery estimator 306 may be configured to determine a critical battery threshold (i.e., a threshold that corresponds to a critical minimum charge and/or minimum voltage for a given battery system, at a level that enables a controlled termination for a vehicle, when necessary) and a preservation battery threshold (i.e., a threshold higher than the critical battery threshold) for the battery pack based on the time until the next sunrise and the battery state for vehicle 320.

Alert monitor 308 may be configured to determine, and to communicate to vehicle 320, a minimum charge threshold and a restart charge threshold, which define battery levels at which vehicle 320 should implement a preservation power mode and transition back to an operational power mode, respectively, said minimum charge and restart charge thresholds being above a critical battery threshold. If battery level for vehicle 320 falls below the minimum charge threshold, a subset of non-flight critical subsystems (e.g., some communications equipment, altitude control system (ACS)) may be turned off to preserve power in the preservation power mode. The restart charge threshold may indicate the charge level at which said subset of non-flight critical subsystems may be powered back on, and may be sufficiently higher than the minimum charge threshold such that restarting one or more non-flight critical subsystems will not cause the battery charge level to fall below the minimum charge threshold immediately or soon after restarting. In some examples, there may be separate thresholds determined for separate non-flight critical subsystems, or other methods of prioritizing shut down and restarting of said subsystems. In some examples, alert monitor 308 further may be configured to alert vehicle 320 to implement a low power mode, wherein a battery state for vehicle 320 falls below a critical battery threshold.

In an example, an operational power mode may include powering most or all systems on vehicle 320 (e.g., ACS and other navigation systems, communications units, communications terminals, propulsion systems). A preservation mode may be implemented when falling below a preservation battery threshold, and may include heating power to all components, but propulsion systems and ACS may be turned off and communications may not transmit or receive. In a low power mode, which may be implemented when falling below a critical battery threshold, vehicle 320 may shut off power to all heating and all communications function, while maintaining only systems necessary for landing vehicle 320.

In an example, alert monitor 308 may send alerts (i.e., including commands) to vehicle 320 to avoid having vehicle 320 fall below a preservation battery threshold (i.e., avoid entering a preservation power mode). Such alerts may disable a first subset of subsystems (e.g., ACS or other non-essential navigation subsystems, LTE or other communications capabilities, and B2X) at night fall (e.g., when the sun falls below a horizon or other predetermined height above or below a horizon) to preserve power. Where the battery state from battery state estimator 304 indicates battery levels falling, or having fallen, below the preservation battery threshold, alert monitor 308 may send additional alerts to vehicle 320 to shut down a second subset of non-flight critical systems (e.g., power off communications unit or other subsystems completely, including some heaters, or otherwise operate a subsystem outside the bounds recommended by its specification, incurring a risk of damaging hardware). Alert monitor 308 may send alerts to vehicle 320 when battery state estimator 304 indicates that the battery state for vehicle 320 has fallen below a critical battery threshold, wherein a third group of non-flight critical systems may be shut down or begin to be rendered inoperable (e.g., heaters to more sensitive components, such as gimbals and terminals), to ensure that flight critical systems can be powered until sunrise (i.e., when the sun rises above a horizon or a predetermined height above a horizon (e.g., 5-15 degrees above the horizon)) or until a threshold amount or rate of solar power is being captured, converted, and/or stored, by the vehicle (e.g., by solar panels 109a-b) again.

In some examples, preservation and critical battery thresholds determined by critical battery estimator 306 also may be provided to flight planner 310. Flight planner 310 may be configured to generate and modify a flight plan for vehicle 320, for example, based on state data (e.g., telemetry) directly from vehicle 320, as well as on battery thresholds determined by critical battery estimator 306. In some examples, alert monitor 308 also may be configured to send alerts to flight planner 310, for example, relating to the minimum charge threshold and restart charge thresholds, as well as other battery state information that may be determined, derived or passed on by critical battery estimator 306. In other examples, flight planner 310 may be configured to send commands relating to a flight plan through alert monitor 308, and alert monitor 308 may be configured to make a final decision regarding which commands to send to vehicle 320.

In FIG. 3B, system 350 may include termination subsystem 351, comprising solar power estimator 352, critical load estimator 354, and termination estimator 356, and vehicle 320. Termination estimator 356 may be configured to determine a probability of vehicle 320 surviving a night (i.e., time frame during which time the solar-powered vehicle is not able to generate solar energy) without cutting power to a flight critical subsystem (e.g., critical avionics and navigation, flight termination unit, landing systems). Solar power estimator 352 may be configured to model, or otherwise determine, a distribution of solar power across the battery system of vehicle 320 over time (e.g., over a night), including an estimation of expected solar power production at any given time. The battery system may include one or more battery packs comprising a plurality of battery cells. Solar power estimator 352 may receive inputs including a vehicle position for vehicle 320 and a time of day (i.e., indicating the sun ray's incident angle and attenuation by a property of vehicle 320, such as a balloon envelope), and may base its estimation of expected solar power production on said inputs. Critical load estimator 354 may be configured to model, or otherwise determine, a distribution of electrical load in a low power mode (e.g., amount of power usage by the vehicle with the components powered off in a low power mode, as described herein, over the night). Said distribution of solar power and distribution of electrical load in low power mode may be provided to termination estimator 356 to determine a probability of surviving the night. Termination estimator 356 may be configured to output a probability of surviving the night (i.e., a likelihood that vehicle 320 will run out of power before the next sunrise) by performing probabilistic computational algorithms or techniques (e.g., Monte Carlo simulations, analytic optimizations). Said output from termination estimator 356 maybe provided to an alert system, such as alert monitor 308, which may be configured to send a message and/or a command to vehicle 320. In other examples, the output from termination estimator 356 also may be provided, directly or through an alert system, to a user interface monitored by a flight engineer (e.g., an interactive user interface by which the flight engineer may send commands to vehicle 320 or other vehicles in a fleet). Termination subsystem 351 may be implemented in an offboard computing system (as shown) (e.g., in distributed computing system 250) in some examples, and in other examples, termination subsystem 351 may be implemented onboard vehicle 320 (not shown).

FIGS. 4A-4B are a charts illustrating exemplary battery charge levels and thresholds for changing power modes, in accordance with one or more embodiments. Charts 400 and 450 may be generated based on modeling or simulations using historical and/or current power data from a fleet of vehicles (e.g., aerial vehicles 120a-b and vehicle 320). Chart 400 illustrates battery charge thresholds according to a sunrise-sunset cycle for an example vehicle (e.g., vehicles 120a-b and 320. In chart 400, solid line 405 may correspond to a preservation battery threshold and dashed line 409 may correspond to a critical battery threshold. As shown, a preservation battery threshold (e.g., solid line 405) may change as a function of time, for example, a time until a next sunset and a time until a next sunrise. Mode 401 may be an operational power mode, which may be maintained by a vehicle whose battery charge remains above solid line 405. Mode 403 may be a preservation mode, which may be implemented by a vehicle whose battery charge falls below solid line 405 and remains above dashed line 409. Mode 407 may be a low power mode, which may be implemented by a vehicle whose battery charge falls below dashed line 409.

In order to avoid inefficiencies in switching back and forth between modes (e.g., powering subsystems on and off), a restart charge threshold may be required in order to return to a higher mode. In some examples, a minimum charge threshold and a restart charge threshold may be derived from a preservation battery threshold, and similar threshold pairs may be derived from a critical battery threshold. In FIG. 4B, chart 450 shows the same modes 401, 403 and 407, along with minimum charge thresholds 454a-c (i.e., horizontal dashed bars) corresponding to two separate points on the preservation battery threshold solid line 405 at T1-T3, respectively. Corresponding restart charge thresholds 452a-c (i.e., horizontal dotted bars) are shown at a charge level above minimum charge thresholds 454a-c, also at T1-T3, respectively. In an example, if a vehicle falls below minimum charge threshold 454b at T2, it may implement mode 403. However, a vehicle already in mode 403 at T2 would require a battery charge level exceeding restart charge threshold 452b at the same T2 in order to return to mode 401. For example, if a vehicle were to fall below line 405 at minimum charge threshold 454b at T1 and regained sufficient charge to re-cross line 405 at minimum charge threshold 454a by T2, it would remain in mode 403. However, if the vehicle were to meet or exceed threshold 452b at T2 or threshold 452c at T3, it would be able to return to mode 401 with a reduced risk of falling back below line 405 again too soon after powering systems back up.

In some examples, certain subsystems or components (e.g., those that are sensitive to on-off power cycles) that are shut off during the night (i.e., after sunset) may not be turned back on (i.e., powered) until a next sunrise (i.e., a time at which the sun is expected to reach a given height above the horizon (e.g., 0 degrees, 5 degrees, 10 degrees, 12 degrees, or more or less) and/or until a threshold amount or rate of solar power generation is reached.

Example Methods

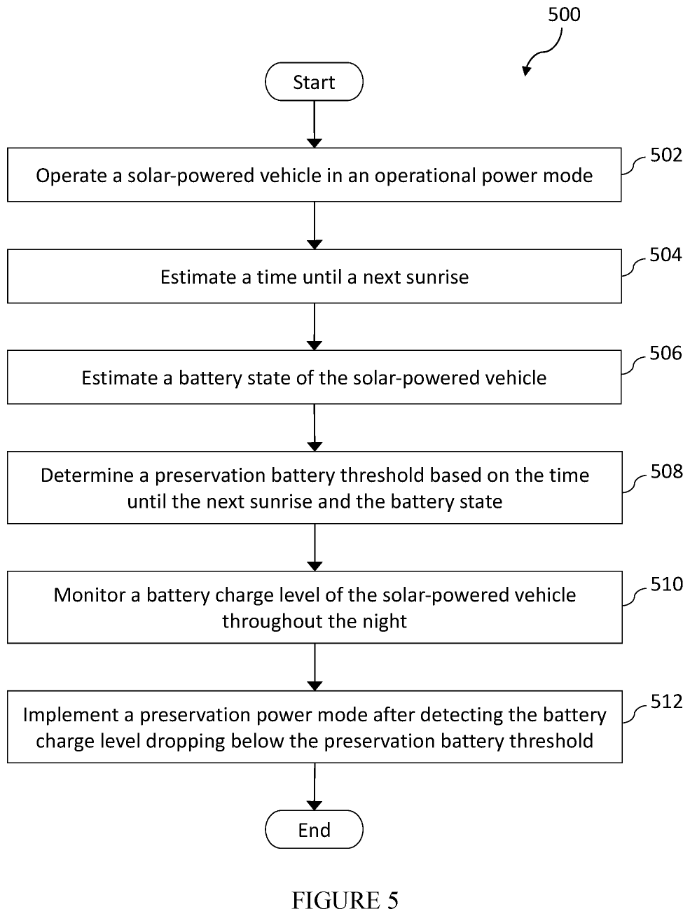

FIG. 5 is a flow diagram illustrating a method for managing nighttime power for solar-powered vehicles, in accordance with one or more embodiments. Method 500 may begin with operating the solar-powered vehicle in an operational power mode at step 502, wherein all or nearly all systems on the solar-powered vehicle are on and able to be powered. A power management system, as described above, may estimate a time until a next sunrise at step 504 (e.g., by sunrise estimator 302 in FIG. 3A). A battery state for the solar-powered vehicle may be estimated at step 506 (e.g., by battery state estimator 304 in FIG. 3A). The battery state may include a battery temperature, charge amount or level, and voltage, for individual battery cells as well as a battery system (i.e., battery pack) taken together. The battery state may be based on state data and other battery and power-related telemetry provided by the solar-powered vehicle. A preservation battery threshold may be determined at step 508 (e.g., by critical battery estimator 306) based on the time until the next sunrise and the battery state, the preservation battery threshold indicating at least a battery charge level. The battery charge level of the solar-powered vehicle may be monitored throughout the night at step 510, and after a detection of the battery charge level dropping below the preservation battery threshold, a preservation power mode may be implemented by the solar-powered vehicle at step 512. In some examples, the implementation of the preservation power mode may be in response to an alert from an alert monitor (e.g., alert monitor 308 in FIG. 3A) indicating the preservation battery threshold. In some examples, a critical battery threshold also may be determined by a critical battery estimator, and a low power mode also may be implemented by the solar-powered vehicle in another step (not shown) after a detection of the battery charge level dropping below the critical battery threshold. In some examples, a plurality of non-flight critical systems may be shut down in the preservation power mode to avoid falling below the critical battery threshold. In some examples, the solar-powered vehicle may be returned to an operational power mode after detecting the battery charge level rising back above a restart charge threshold, wherein the restart charge threshold is sufficiently higher than the preservation battery threshold such that returning the solar-powered vehicle to the operational power mode will not cause the battery charge level to drop back below the preservation battery threshold within a predetermined period of time.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A nighttime power management system for a solar-powered vehicle, the system comprising:
a sunrise estimator configured to estimate a time until a next sunrise;
a battery state estimator configured to estimate a battery state;
a critical battery estimator configured to determine a battery threshold, below which one or more subsystems may be powered off; and
an alert monitor configured to determine, and communicate to the solar-powered vehicle, a charge threshold and a restart charge threshold, the charge threshold indicating a first minimum battery charge below which a preservation power mode will be implemented by the solar-powered vehicle and the restart threshold indicating a second minimum battery charge above which the solar-powered vehicle may return to an operational power mode.

2. The system of claim 1, wherein the battery threshold comprises a preservation battery threshold, the charge threshold being based on the preservation battery threshold.

3. The system of claim 1, wherein the solar-powered vehicle is configured to shut off power to a first subset of non-flight critical subsystems in the preservation power mode.

4. The system of claim 3, wherein the first subset of non-flight critical subsystems comprises one or more of a propulsion system, an altitude control system, and communication transmit and receive capabilities.

5. The system of claim 1, wherein the solar-powered vehicle is configured to power on at least a communications unit, an altitude control system, and a plurality of heaters in the operational power mode.

6. The system of claim 1, wherein the battery threshold comprises a critical battery threshold, below which a low power mode will be implemented by the solar-powered vehicle.

7. The system of claim 6, wherein the solar-powered vehicle is configured to shut off power to a second subset of non-flight critical subsystems in the low power mode.

8. The system of claim 7, wherein the second subset of non-flight critical subsystems comprises a communications unit and a plurality of heaters including a heater for a communications terminal.

9. The system of claim 6, wherein the solar-powered vehicle is configured to maintain power to a set of flight critical subsystems during the preservation power mode, the low power mode, and the operational power mode, the set of flight critical subsystems including a flight termination unit.

10. The system of claim 1, further comprising a termination subsystem including:
a solar power estimator configured to estimate distribution of power available until the next sunrise; and
a critical load estimator configured to estimate distribution of electrical load for operating in a low power mode until the next sunrise.

11. The system of claim 10, further comprising a termination estimator configured to determine a probability of the solar-powered vehicle maintaining power to a set of flight critical subsystems until a next sunrise.

12. The system of claim 11, wherein the set of flight critical subsystems includes one or both of an avionics subsystem and a landing system, the landing system including a flight termination unit.

13. The system of claim 11, wherein the termination estimator is configured to determine the probability by performing a probabilistic computation algorithm.

14. The system of claim 13, wherein the probabilistic computation algorithm comprises a plurality of Monte Carlo simulations.

15. The system of claim 1, wherein the solar-powered vehicle is configured to maintain power to a set of flight critical subsystems during the preservation power mode, the low power mode, and the operational power mode, the set of flight critical subsystems including a flight termination unit.

16. The system of claim 1, further comprising a flight planner configured to generate and modify a flight plan for the solar-powered vehicle, wherein the flight planner is configured to modify the flight plan in response to the battery state estimated by the battery state estimator.

17. The system of claim 17, wherein the flight planner further is configured to modify the flight plan in response to an alert automatically sent by the alert monitor, the alert associated with the charge threshold and the restart threshold.

18. A method of managing power of a solar-powered vehicle during a night, the method comprising:
operating the solar-powered vehicle in an operational power mode;
estimating a time until a next sunrise;
estimating a battery state;
determining a preservation battery threshold based on the time until the next sunrise and the battery state;
determining a minimum charge threshold based on the preservation battery threshold;
monitoring a battery charge level of the solar-powered vehicle throughout the night; and
after detecting the battery charge level dropping below the minimum charge threshold, implementing a preservation power mode.

19. The method of claim 18, wherein the battery state comprises one or more of a battery temperature, a battery charge, and a battery voltage, of a battery on the solar-powered vehicle.

20. The method of claim 18, further comprising determining a critical battery threshold, wherein a first subset of non-flight critical systems is shut off in the preservation power mode to avoid falling below the critical battery threshold.

21. The method of claim 18, further comprising, after detecting the battery charge level dropping below the critical battery threshold, implementing a low power mode, wherein a second subset of non-flight critical systems is shut off.

22. The method of claim 18, further comprising:
determining a restart charge threshold based on the preservation battery threshold and upon detecting the battery charge level rising back above a restart charge threshold; and
returning the solar-powered vehicle to the operational power mode,
wherein the restart charge threshold is a sufficient amount higher than the preservation power mode such that returning the solar-powered vehicle to the operational power mode will not cause the battery charge level to drop back below the minimum charge threshold within a given period of time.
